(19) United States
(12) Patent Application Publication
(10) Pub. No.: US 2007/0093096 A1
(43) Pub. Date: Apr. 26, 2007

(54) Spring system, in particular for bicycles

(75) Inventor: Martin Achenbach, Biel (CH)

Correspondence Address: GREER, BURNS & CRAIN, 300 S WACKER DR, 25TH FLOOR, CHICAGO, IL, 60606, US

(73) Assignee: DT SWISS INC.

(21) Appl. No.: 11/584,106

(22) Filed: Oct. 20, 2006

(30) Foreign Application Priority Data
Oct. 21, 2005 (DE) 10 2005 050 885.5

(51) Int. Cl. H01R 13/44

(52) U.S. Cl. 439/140

(57) ABSTRACT

A spring system, in particular for bicycles with a first spring and a second spring and a load-applying portion located to act therebetween. Between the first spring and the second spring a piston is located which is movably accommodated at a housing element. The housing element is made of a fibrous composite material and includes an inner wall. The first spring is a pneumatic spring and the inner wall of the housing element is the bearing surface of the piston.

### BACKGROUND

The invention relates to a spring system, in particular for bicycles.

In the field of bicycles in particular in the professional and semi-professional field but also in the field of serious recreational cyclists the weight and stress tolerance of bicycle components plays a decisive role. Therefore the weight plays a role also in spring systems for bicycles.

From US 2005/00 29 719 A1 a self-centering strut having two all-metal elastic springs for harvesters and agricultural tractors has become known wherein the solid elastic springs are arranged in a dust protective housing of plastic or a fibrous composite material. The known strut is configured for high loads where the weight only plays a minor role.

GB 23 85 568 A discloses a suspension fork for bicycles having an inner tube of metal and an outer tube of a fibrous composite material. The inner tube has a conventional spring and damping system arranged at it.

The DE 86 05 591 U1 has disclosed a twin-tube shock absorber where between two cylindrical metal tubes a piston rod guide body is provided which is equipped with a metal guide bushing and which itself is made of plastic and serves as an end cap of the oil-filled chamber.

From DE 101 22 730 A1 a spring and damper system for bicycles has become known where between a first load-applying portion and a second load-applying portion, a first spring configured as a pneumatic spring and a second spring are provided. Between said first and said second spring, a metallic pneumatic spring housing has a piston positioned in it and wherein the inner surface forms the piston bearing surface and which sealingly closes the pneumatic spring. The known system is of a high quality but also has a considerable weight.

### SUMMARY

It is therefore the object of the present invention to provide a spring system for bicycles both of good quality and light in weight.

The spring system according to the invention is in particular suited to bicycles, comprising a first load-applying portion and a second load-applying portion so as to allow to apply the forces to the spring system. At least one first spring and at least one second spring are located to act between the first and the second load-applying portion. Between the first spring and the second spring at least one piston is located which is accommodated at a housing element. Said piston is accommodated to be movable relative to said housing element. According to the invention the housing element is made of a fibrous composite material and comprises an inner wall. The first spring is configured as a pneumatic spring and the inner wall of the housing element forms the bearing surface of the piston which seals the pneumatic spring which is subjected to excess pressure.

The invention has many advantages. A spring system according to the invention is considerably less in weight than a conventional spring system while stability, stress tolerance, and durability are even improved. The weight could thus be reduced, given comparable fitted dimensions and otherwise comparable specifics, by approximately 5% to 10%, resulting in saving approximately 10 to 20 grams in weight. This is a significant progress since each gram counts for both professionals and ambitious amateurs.

The housing element of fibrous composite material must, in addition to its technical functionality, also be configured to be optically pleasant since its outside is visible.

The housing element must further offer a perfectly tight seat of the piston so as to permanently and safely retain the fluid in the appropriate spring chamber. An uneven surface of the housing element being in contact with the piston could not meet this requirement. Requirements for manufacture are thus very exacting. There had been considerable doubt as to meeting these requirements which had, however, been eliminated by the invention.

The surface being in contact with the piston is as a rule the inner surface of the housing element which is preferably about cylindrical on the whole. The contact surface is also preferably cylindrical, extending at least over the cylinder stroke length which in spring systems for bicycles amounts to several 10 mm, as a rule between approximately 25 mm and approximately 100 mm.

Manufacturing such a radially inwardly contact surface over this length using a fibrous composite material did not appear to be possible thus far since the core used in manufacturing cannot be conical but must comprise a constant diameter, i.e. it must in particular be cylindrical so as to provide the in particular cylindrical hollow space in the housing element.

It has been found that when using a metal core on which the fibrous composite material is applied it is possible to effectively manufacture such a housing element. This is done by depositing the fibrous composite material on the cylindrical core which is matched to the inner shape of the housing element. An outer mold consisting of multiple elements which radially encase the mold is then employed to apply pressure. The mold is concurrently heated. When the mold has been cooled and cured the core can be removed since the material is selected such that the coefficient of thermal expansion of the core is higher than that of the fibrous composite material. This causes the core to contract more intensely than the housing element such that the core can be removed.

Surprisingly it has been found that a housing element and spring system manufactured in this way meet the superior requirements. Thus also the external surface of the housing element can be designed to be well-shaped and aesthetically pleasing such that the external surface corresponds to the worth of the spring system. This had not been anticipated since as a rule, known components of fibrous composite materials have two surfaces of considerably different qualities; namely, in most cases one surface is smooth and even, while the other will show waviness and unevenness. Generally this is no problem since e.g. in frames or hubs, unevenness on the inside surface is not visible. This is a different case. However, the manufacturing process allows to manufacture both surfaces in a high quality since smooth molds are used for the inner and the outer surfaces. In contrast to this the prior art mostly uses a smooth mold for one side and for the other side an inflatable counterpart e.g. a silicone hose is pumped up to generate the necessary counterpressure.

In preferred specific embodiments of the invention the second spring is e.g. an elastomeric spring while other pneumatic springs may be provided.

Preferably the housing element may at least in part consist of a fibrous composite material with a thermosetting matrix material.

Preferably the housing element consists at least in part of a fibrous composite material with a thermoplastic matrix material.

In manufacturing two or more different fiber types may be used namely, a first fiber type of e.g. a thermoplastic material and a second type of reinforcing fibers. It is also preferred that some fibers are combination fibers consisting at least of a reinforcing fiber and a thermoplastic material.

The choice of material notwithstanding, the fibers used are preferably interconnected in particular by means of a process selected from a group of processes including machine knitting, weaving, knotting, knitting, braiding, and spinning. Prefabricated tissues, hoses, mats and/or profiles may in particular be used.

The or one housing element of the spring system according to the invention comprises in particular a cylindrical inner wall. This means that at least a portion of the inner wall is cylindrical. The inner wall of the housing element is in particular the bearing surface of the piston. The piston may be accommodated to be floating in the housing element.

Also surprisingly it has been found that a spring system according to the invention with a housing element of a fiber-reinforced material is permanently fully functional. There had been doubts since in this type of housing elements e.g. of aluminum the surfaces coming into contact with the piston are anodized to permanently withstand stresses. It has now been found that in this case this is not necessary when using two cylinders placed one inside the other with a piston inbetween which is movable relative to one or both cylinders and where the inner wall of the outer cylinder is made of said fibrous composite material.

The outstanding durability in the present invention is caused among other things by the inner bearing surface being well protected from contamination since said surface has traveling along it only that piston which is e.g. firmly connected with said first cylinder or and permanently remains inside said outer cylinder. Thus it is not necessary to coat the outer cylinder or housing element with polytetrafluoroethylene (Teflon; PTFE). The invention may also be employed in a floating piston provided to float between the inner and the outer cylinder.

For a housing element made of a thermoplastic matrix material said material is heated at least up to melting temperature. The matrix material melts and distributes. Since external pressure is concurrently applied, smooth surfaces are generated on the inside and the outside. The inner surface is without any further treatment suitable as a piston bearing surface while the outer surface is also smooth, offering an optically pleasant look.

Small tabs on the outside between the elements of the multi-part outer mold may be manufactured and left on purpose so as to create a pattern or they can be removed in a later step.

It is also conceivable to configure the outer wall of the housing element to be the bearing surface of the piston. In this case the outer wall must be manufactured to be smooth. Furthermore it is also conceivable to shape both the inner wall and the outer wall to be cylindrical thus to serve as the bearing surface for two different pistons. In such cases an optional coating with polytetrafluoroethylene (PTFE) or the like is conceivable.

The housing element of the spring system may be joined with a cover lid.

Preferred specific embodiments provide the housing element to be threaded e.g. for screwing on the lid.

It is in particular preferred to configure the thread integrally with the housing or to form it in the housing element. This is in particular advantageous since the further step of gluing in a threaded ring is omitted. Weight is also saved. Preferably the thread is provided directly on the core and directly wound on during production. This procedure has also unexpectedly proven to be a success, moreover since a considerable pressure difference must be sealed off toward the ambience via the thread.

In other embodiments it is also possible to attach a thread element or glue in a thread insert.

All of the embodiments preferably provide that the spring system comprises at least one damping means. In all of the cases a first cylinder is preferably provided extending axially movably into the housing element formed as the second cylinder.

Furthermore a third spring may be provided supported on the floating piston and on the first cylinder.

The applicant reserves the right to apply for protection for a method directed at the manufacture of a housing element and in particular a housing element for a spring system. The method according to the invention serves in particular to manufacture a housing element for a spring system and preferably to manufacture a spring system for bicycles.

The method for manufacturing the housing element comprises the following steps:

a) surrounding a cylindrical core with a fibrous composite material,

b) closing the mold from outside,

c) heating the mold,

d) cooling the mold,

e) removing the core.

Preferably the mold is closed with multiple mold elements fed from outside and opened after or before removing the core. Preferably the mold elements are symmetrically distributed about the periphery.

The housing element is in particular substantially cylindrical, serving to receive a piston placed inside to be axially displaceable but tight.

The finished spring system preferably comprises a first and a second load applying portion between which at least one first and at least one second spring are arranged to be effective.

Preferably the core consists of a material, in particular a metal, which in cooling shrinks more than the fibrous composite material of the housing element.

Manufacture is possible using a thermosetting matrix material. It is also preferred to use a thermoplastic matrix material.

Heating is preferably carried out in an oven at a temperature of at least 150° C. and in particular at least for a period of 2 minutes, in particular for a period of 5 to 30 minutes. The parameters may considerably differ from those indicated, depending in particular on the materials used.

A particularly rapid cooling may be achieved with a liquid such as water.

### BRIED DESCRIPTON OF THE DRAWINGS

Further advantages and embodiments of the present invention can be taken from the accompanying drawings.

FIG. 1 is a sectional view of a spring system according to the invention in a first position;

FIG. 2 is a sectional view of the spring system of FIG. 1 in a second position;

FIG. 3 is a schematic transverse sectional view of a housing element;

FIG. 4 is a sectional view of another spring system according to the invention;

FIG. 5 is a mold for manufacturing a housing element; and

FIG. 6 is another mold for manufacturing a housing element.

### DETAILED DESCRIPTION OF THE PREFERRED EMBODIMENT

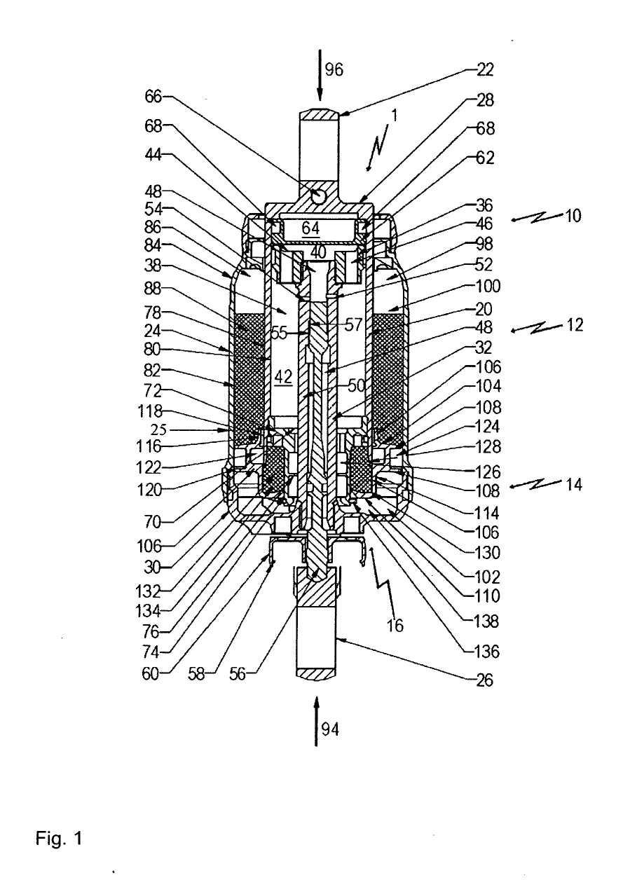

FIG. 1 shows a schematic illustration of an exemplary embodiment of a spring system 1 according to the invention. The spring system comprises multiple springs 10, 12, 14, 16 and a damper means 18. The invention is not limited to the illustrated embodiment. According to the invention, differently structured spring systems may be used as well.

The configuration according to FIG. 1 provides a first damper housing or housing element 26 configured as a cylinder 20 to which a first eyelet-type load applying portion 22 is fixedly connected at the front face 28. Furthermore a second damper housing or housing element 25 configured as a cylinder 24 is provided, which is threadedly and fixedly connected with a lid 30. The lid 30 comprises a likewise eyelet-type second load applying portion 26. The first cylinder 20 is received in the damper housing 25 or the second housing element or cylinder 24 to be axially displaceable.

The damper housing 25 or the cylinder 24 in this case is made of a fibrous composite material. For this purpose a fibrous composite material is deposited on a cylindrical core having precisely specified dimensions. Prefabricated pads, woven fabrics or prepregs or the like are preferably used to speed up the manufacturing process. It is also possible to use other methods for depositing the fibrous composite material.

After winding the material around the core, the mold is closed by means of a multipart outer mold so as to seal the inner mold radially inwardly. The outer mold may comprise for example three segments covering angles of for example 120° each. Small gaps of for example 1/10 to approximately 5/10 mm may remain between the individual segments to ensure that excess matrix material can escape and to make sure that no voids remain in the workpiece. Instead of small gaps, tiny or minuscule holes in the segments are conceivable for air and material to escape.

Two or four or more segments are likewise possible. While the inner mold is being heated, the multipart outer mold exerts pressure on the mold to allow the material to distribute homogeneously and free of voids. If thermoplastic matrix materials are used, it is sufficient to heat the mold for a short time to a temperature above the melting point. With thermosetting materials the heating phase is longer to ensure optimum curing.

The core material is chosen such that in cooling the core will contract more than does the fibrous composite material such that the core can be removed after cooling. Inflatable cores cannot be used since reproducible manufacture of a cylindrically smooth and homogeneous surface is not possible. The outer dimensions of the core are matched to the manufacturing process and the material so as to obtain an accurately fitting component after cooling.

After cooling and after finishing if required the cylinder 24 or the damper housing 25 can be integrated into the spring system.

For this purpose the cylinder 24 is screwed via the thread 29 to the lid 30 which is fixedly connected with a piston rod 32 which extends in axial direction in the second cylinder 24 and receives a damper piston 36 in the first cylinder 20. Said first cylinder 20 is located to be axially movable relative to the damper piston 36 which is located at the interior 38 of the first cylinder 20, separating a first damper chamber 40 from a second damper chamber 42.

The damper piston 36 is provided with multiple passages 44, 46 which connect the first and the second damper chamber 40, 42 with one another. The movement of the damper fluid (in particular oil) present in the damper chambers 40, 42 from one to the other chamber causes damping to occur.

The damping openings 44, 46 may be provided with valves such as check valves etc. to achieve different damping action in opposite damping directions. The valves may be configured for example as spring leaves mounted to the damper piston 36 such that a pressure load will cause the oil to flow from the first into the second chamber while a tensile load will prevent any oil flow.

The piston rod 32 comprises an axially extending hollow space 48 surrounded by a piston rod casing wall 50 in which damping passages 52, 54 are provided which connect the hollow space 48 with the second damper chamber 42.

The hollow space 48 of the piston rod 32 has an axially movable control rod 56 extending into it which by way of axial displacement can close the damping passage 52 and/or the damping passage 54 so as to prevent oil from moving through said openings 52 and 54 between the second chamber 42 and the hollow space 48. In other axial positions the control rod 56 releases the damping passage 52 (and/or 54).

The control rod 56 comprises an external thread 55 engaging with an internal thread 57 located at the piston rod 32 so as to cause an axial displacement of the control rod 56 by way of rotating the control rod 56 relative to the piston rod 32 so as to release and close the damping openings 52 and/or 54. The control rod 56 is connected with an adjustment means 58 which includes an adjusting wheel 60 for rotating and axially displacing said control rod 56. In the configuration according to FIG. 1 the control rod 56 is supported via the control rod 32 against the lid 30 of the second cylinder 24.

The hollow space 48 is open toward the first chamber 38 such that with a suitable axial position of the control rod 56, oil can flow between the first chamber 38 and the second chamber 42 through the damping opening 54 and 52 respectively, and vice versa. A damping effect occurs in this way.

On the side facing away from the second cylinder 24 the first damping chamber 38 is bordered by a floating dividing piston 62 which in turn borders a gas-filled chamber 64 which functions as a pneumatic spring or spring means 10. The pneumatic spring may be filled with gas through a valve opening 66. The dividing piston 62 is sealed from the first cylinder 20 by means of suitable sealing means 68.

The second damper chamber 42 is delimited at its end facing away from said first damper chamber 40 by a damper lid 70 which comprises a portion 74 extending in the axial direction and a portion 72 extending from it in a radial direction.

The damper lid 70 further comprises a second radial portion 76 which extends radially inwardly from the axial portion 74 of the damper lid 70. An opening in the radial portion 76 of the damper lid 70 has the piston rod 32 extending through it.

Between the outer surface 78 of the casing wall of the first cylinder 20 and the inner surface 82 of the casing wall 84 of the second cylinder 24 a space 86 is provided in which a hollow-cylinder spring device 12 is mounted which is configured as an elastomeric spring herein, functioning as a negative spring 88.

The elastomeric negative spring 88 is dimensioned such that under axial pressure load of the damper system 1, as is schematically indicated by the arrows 94, 96, it is untensioned in the axial direction before the spring system 1 is wholly retracted. As soon as the elastomeric negative spring 88 is wholly untensioned in the axial direction and the spring system 1 is retracted further, a material-free chamber area 98 of the chamber 100 in which the elastomeric negative spring 88 is located, will increase during said further retraction.

With one end 104 facing the spring device 14 which is configured as a positive spring 102, said elastomeric negative spring 88 contacts a floating, cup-type and substantially rotationally symmetric piston 106, at least while it is loaded in the axial direction such that the floating piston 106 will be loaded by the elastomeric negative spring 88.

The floating piston 106 comprises a first wall portion 108 extending substantially in radial direction and a second wall portion 110 extending substantially in radial direction and a wall portion 112 extending substantially in axial direction, part of which forms a connecting wall 114 between said first radial wall portion 108 and said second radial wall portion 110.

The axial wall portion 112 or the first radial wall portion 108 are respectively supported with their radially inwardly areas on the outer surface 78 of the casing wall 80 of the first cylinder 20. The radially outwardly area 120 of the first radial wall portion 108 is supported on the inner surface 82 of the casing wall 84 of the second cylinder 24.

In the region of the axial wall portion 112 or the first radial wall portion 108 a radially inwardly recess 122 is provided for accommodating a—not shown—sealant for sealing the floating piston 106 from the first cylinder 20.

In the radially outwardly region 120 of the first radial wall portion 108 of the floating piston 106 a recess 124 is provided for accommodating a not shown sealant for sealing the floating piston 106 from the second cylinder 24.

The first radial wall portion 108 extends radially outwardly from the axial wall portion 112 of the floating piston 106.

In the end region of the axial wall portion 112 of the floating piston 106 facing away from the axial projection 116 the second radial wall portion 110 extends radially inwardly.

In the second radial wall portion 110 a concentric through passage 126 is provided through which extends the axial portion 74 of the damper lid 70 and, radially inwardly of said axial portion 74, the damper piston rod 32 with the control rod 56 received therein.

The radial portion 72 of the damper lid 70 is mounted inside said first cylinder 20 and spaced apart from the end 128 of the casing wall 80 of the first cylinder 20 facing away from the first load applying portion 22.

The end 128 of the casing wall 80 of the first cylinder 20 functions as abutment 130 for the floating piston 106 and delimits the axial displacement of this floating piston 106 in the direction of the first load applying portion 22.

In the stop position shown in FIG. 1 where the piston 106 contacts the abutment 130 the second radial wall portion 110 contacts the end 128 of the casing wall 80 of the first cylinder 20.

In this stop position an extension chamber 132 is delimited by the radial portion 72 of the damper lid 70, by the axial portion 74 of the damper lid 70, by the second radial wall portion 110 of the floating piston 106 and by the inner surface 82 of the casing wall 80 of the first cylinder 20 in which an elastomeric spring 134 is positioned designated herein as third spring 16 which is compressed in the position according to FIG. 1.

FIG. 1 further shows an abutment 136 which delimits the range of movement of the floating piston in the direction facing away from the first load applying portion 22.

The positive spring 102 is configured as a pneumatic spring and is supported at the lid 30 and at the floating piston 106 on the side facing away from the springs 16, 12.

The force of the positive spring 102 acting on the piston acts at the floating piston 106 against the resulting forces which are transmitted into the piston 106 in axial direction from the negative spring 12 and the spring 16.

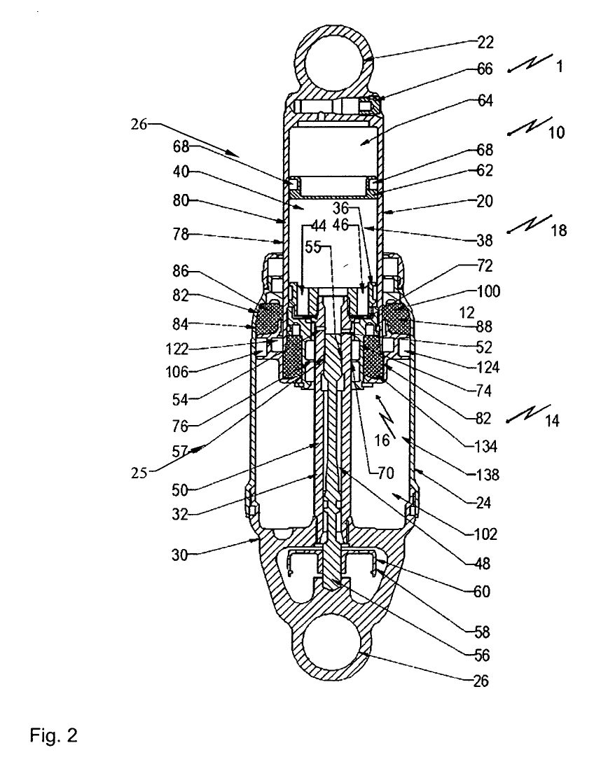

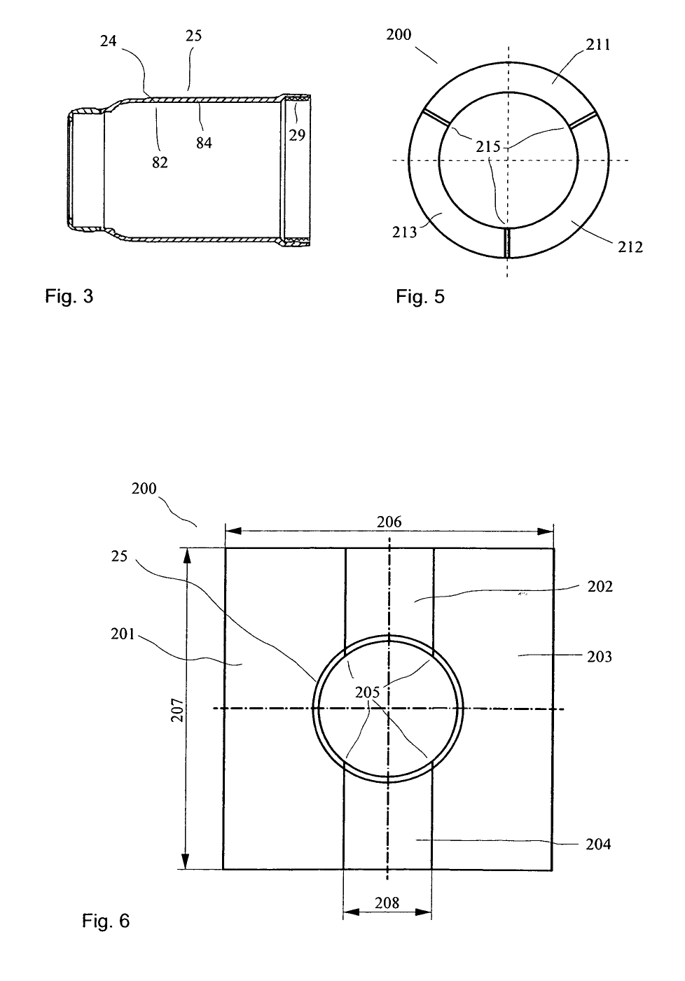

FIG. 2 shows the spring system 1 according to FIG. 1 in a second, substantially wholly extended position.

In this position the elastomeric negative spring 88 is compressed and acts on the piston 106. The elastomeric spring 134 is wholly untensioned if required. The volume of the chamber which receives the elastomeric spring 134 is enlarged correspondingly.

The positive spring 102 is also substantially untensioned. The volume of the chamber 138 which receives the positive spring 102 is enlarged relative to the position according to FIG. 1.

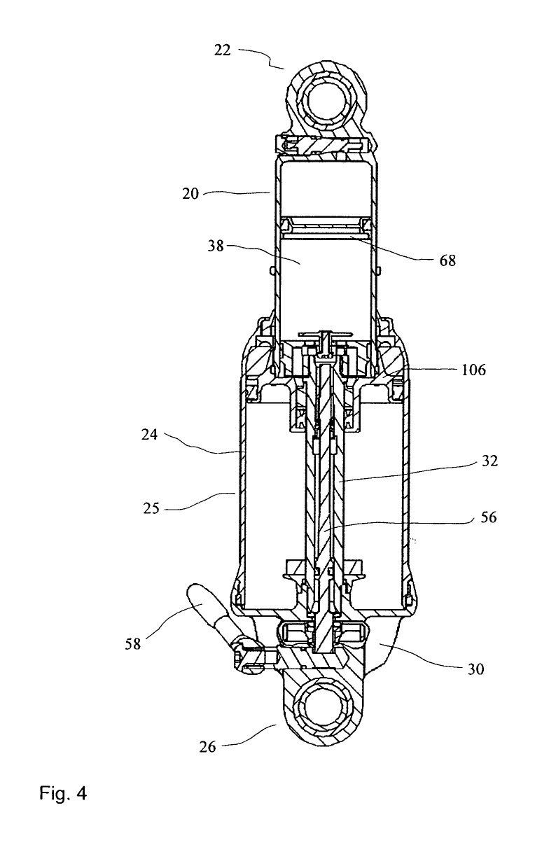

FIG. 4 illustrates another embodiment of a damper. Like or similarly acting components are indicated at the same reference numerals as in the previous embodiment.

The damper also comprises a first cylinder 20 and a second cylinder 24 which serves as a radially outwardly damper housing 25 and is manufactured of a fibrous composite material. At the end of the cylindrical damper housing 24 a thread 29 is formed integrally in the damper housing 25 for a lid 30 to be screwed in. The thread 29 has been manufactured along with manufacture of the damper housing 25.

The first cylinder 20 has a movable dividing piston 68 provided in it. Unlike the previous embodiment, this piston 106 is not floating. The piston 106 is fixedly connected with the first cylinder 20 and received in the second cylinder 24 or damper housing to be axially movable. The piston 106 slides on the inner surface 82 of the damper housing 25.

FIG. 5 illustrates a mold 200 for the manufacture of a housing element 25 comprising three outer mold elements 211, 212 and 213, each covering an angular range of 120°. For the manufacture of the housing element or spring housing 25 the mold elements 211 to 213 are positioned so as to form a cylindrical space within the mold 200. The mold 200 is closed and the fibrous composite material is heated, forming the housing element 25 after cooling down. The mold elements are pressed towards each other, but slits 205 remain between them, through which excessive material discharges.

FIG. 6 illustrates another advantageous mold 200 which herein comprises four mold elements 201, 202, 203 and 204. The two outer mold elements 201 and 203 and the two mold elements 202 and 204 positioned in-between are resemble one another in shape. The mold elements 201 and 203 are approximately U-shaped while the mold elements 202 and 204 provided in-between are formed as sliders.

It is a considerable advantage of this configuration that the generally rectangular basic shape allows the individual parts to be properly molded to one another since screwing elements or the like may apply external pressure. The mold elements are abutting each other, so that only tiny gaps 205 or joints remain. In total this will result in an improved outer surface of the housing element 25 since during manufacturing nearly no material will escape from the slits 205 between the mold elements. Excessive material discharges mainly at the ends. This allows to keep finishing of the outer surface to a minimum.

During manufacturing of the housing element 25 the fibrous composite material is heated such that it can partially liquefy. In total, the volume will decrease which may be taken into account in sizing the mold dimensions. It is also conceivable to adjust the slider-type mold elements 202 and 204 during the machining process to allow adjustment to changing conditions.

1. A spring system, in particular for bicycles, comprising:
a first load applying portion and a second load applying portion;
at least one first spring and at least one second spring which are located to act between the first and the second load applying portion; and
at least one piston located between said first spring and said second spring and movably received at a housing element;
said housing element consists of a fibrous composite material and comprises an inner wall wherein said first spring is a pneumatic spring and the interior wall of the housing element forms the bearing surface of the piston which seals the pneumatic spring.

2. The spring system according to claim 1 wherein the interior wall is configured to be cylindrical.

3. The spring system according to claim 1 wherein said second spring is an elastomeric spring.

4. The spring system according to claim 1 wherein the housing element is at least in part composed of a fibrous composite material with a thermosetting matrix material.

5. The spring system according to claim 1 wherein the housing element is at least in part composed of a fibrous composite material with a thermoplastic matrix material.

6. The spring system according to claim 1 wherein the outer wall of the housing element is the bearing surface of the piston.

7. The spring system according to claim 1, characterized in that the piston is mounted to float in the housing element.

8. The spring system according to claim 1 wherein the housing element comprises a thread.

9. The spring system according to claim 8 wherein the thread is integrally formed at the housing element.

10. The spring system according to claim 8 wherein the housing element comprises an adjoined thread element.

11. The spring system according to claim 1 wherein the housing element comprises a lid.

12. The spring system according to claim 1, characterized in that at least one damper means is provided.

13. The spring system according to claim 1, characterized by a first cylinder extending axially movably into the housing element formed as the second cylinder.

14. The spring system according to claim 1, characterized in that the piston is fixedly connected with the first cylinder.

15. The spring system according to claim 1, characterized in that a third spring is supported on the floating piston and on the first cylinder.

16. The spring system according to claim 1, characterized in that the piston is supported on the radially outwardly surface of the casing wall of the first cylinder.

17. A suspension fork in particular for bicycles comprising a fork and at least one spring system arranged thereat, comprising
a first load applying portion and a second load applying portion;
at least one first spring and at least one second spring which are located to act between the first and the second load applying portions; and
at least one piston located between said first spring and said second spring and movably received at a housing element;
said housing element consists of a fibrous composite material and comprises an inner wall wherein said first spring is a pneumatic spring and the interior wall of the housing element forms the bearing surface of the piston which seals the pneumatic spring.
